(19) United States
(12) Patent Application Publication
(10) Pub. No.: US 2025/0138644 A1
(43) Pub. Date: May 1, 2025

(54) METHOD AND APPARATUS FOR CONTROLLING ELECTRONIC DEVICE, ELECTRONIC DEVICE, AND STORAGE MEDIUM

(71) Applicant: Beijing Zitiao Network Technology Co., Ltd., Beijing (CN)

(72) Inventors: Ziyuan LIU, Beijing (CN); Jia GUO, Beijing (CN); Jianhang SUN, Beijing (CN)

(21) Appl. No.: 18/933,459

(22) Filed: Oct. 31, 2024

(30) Foreign Application Priority Data
Oct. 31, 2023 (CN) 202311426683.2

(51) Int. Cl. G06F 3/01; G06F 3/16; G06T 19/20

(52) U.S. Cl. CPC G06F 3/017; G06F 3/013; G06T 19/20; G06F 3/167; G06T 2219/2016

(57) ABSTRACT

A method includes: displaying a physical environment of a user through the display generation component; generating at least one second object on a first object in the physical environment in response to a preset processing flow; detecting, through the eye tracking device, that a gaze of the user points to a target second object of the second objects to generate a visual indication object; detecting a hand gesture of the user through the gesture detection device, and controlling the target second object based on the hand gesture and the visual indication object; and determining attribute information of the target second object in a case that a demand of the user is satisfied by adjusting a fitting degree between the target second object and the first object based on the hand gesture.

### CROSS-REFERENCE TO RELATED APPLICATION(S)

This application claims priority to Chinese Application No. 202311426683.2, filed Oct. 31, 2023, the disclosure of which is incorporated herein by reference in its entity.

### FIELD

The disclosure relates to the technical field of computers, in particular to a method and an apparatus for controlling an electronic device, an electronic device, and a storage medium.

### BACKGROUND

Extended reality includes virtual reality, mixed reality, augmented reality, etc. In a mixed reality world, objects in the real world and their corresponding virtual models can be displayed. The virtual models are required to be calibrated before displayed.

### SUMMARY

The disclosure provides a method and an apparatus for controlling a mixed reality device, an electronic device, and a storage medium.

The disclosure employs the following technical solution:

In some embodiments, the disclosure provides a method for controlling an electronic device. The electronic device includes a display generation component and one or more input devices the input device includes an eye tracking device and a gesture detection device. The method includes:
displaying a physical environment of a user through the display generation component;
generating at least one second object on a first object in the physical environment in response to a preset processing flow;
detecting, through the eye tracking device, that a gaze of the user points to a target second object of the second objects, and generating a visual indication object;
detecting a hand gesture of the user through the gesture detection device, and controlling the target second object based on the hand gesture and the visual indication object; and
determining attribute information of the target second object in a case that a demand of the user is satisfied by adjusting, based on the hand gesture, a fitting degree between the target second object and the first object.

In some embodiments, the disclosure provides an electronic device. The electronic device includes: a display generation component and one or more input devices, where the input device includes an eye tracking device and a gesture detection device;
the display generation component is configured to display a physical environment of a user;
the display generation component is further configured to generate at least one second object on a first object in the physical environment in response to a preset processing flow;
the eye tracking device is configured to detect a pointing direction of a gaze of the user;
the display generation component is further configured to detect, through the eye tracking device, that the gaze of the user points to a target second object of the second objects, and generate a visual indication object;
the gesture detection device is configured to detect a hand gesture of the user;
the display generation component is further configured to detect the hand gesture of the user through the gesture detection device, and control the target second object based on the hand gesture and the visual indication object; and
the display generation component is further configured to determine attribute information of the target second object in a case that a demand of the user is satisfied by adjusting, based on the hand gesture, a fitting degree between the target second object and the first object.

In some embodiments, the disclosure provides an electronic device. The electronic device includes: at least one memory and at least one processor; where
the memory is configured to store program codes, and the processor is configured to execute the method described above by calling the program codes stored in the memory.

In some embodiments, the disclosure provides a computer-readable storage medium. The computer-readable storage medium is configured to store program codes, where the program codes, when run by the processor, cause a processor to execute the method described above.

According to the method for controlling an electronic device provided by the embodiment of the disclosure, the target second object is selected based on the gaze of the user, and the target second object is controlled by using the hand gesture and the visual indication object. A tool such as a handle is unnecessary during the entire process, such that use experience of the user is better, and the method can be used for calibrating the first object.

### BRIEF DESCRIPTION OF THE DRAWINGS

According to the method for controlling an electronic device provided by the embodiment of the disclosure, the target second object is selected based on the gaze of the user, and the target second object is controlled by using the hand gesture and the visual indication object. A tool such as a handle is unnecessary during the entire process, such that use experience of the user is better, and the method can be used for calibrating the first object.

FIG. 1 is a schematic diagram of using a mixed reality device according to an embodiment of the disclosure.

FIG. 2 is a schematic diagram of executing a calibration flow according to an embodiment of the disclosure.

FIG. 3 is a flowchart of a method for controlling an electronic device according to an embodiment of the disclosure.

FIG. 4 is a schematic diagram of the score of an object in a mixed reality world according to an embodiment of the disclosure.

FIGS. 5-13 are schematic diagrams of an execution process of a method for controlling an electronic device according to an embodiment of the disclosure.

FIG. 14 is a schematic structural diagram of an electronic device according to an embodiment of the disclosure.

### DETAILED DESCRIPTION OF EMBODIMENTS

Embodiments of the disclosure will be described below in more detail with reference to the accompanying drawings. Although some embodiments of the disclosure are shown in the accompanying drawings, it should be understood that the disclosure can be implemented in various forms and should not be constructed to be limited to the embodiments set forth herein. On the contrary, these embodiments are provided for facilitating more thorough and complete understanding of the disclosure. It should be understood that the accompanying drawings and the embodiments of the disclosure are merely used for illustration rather than limitation to the protection scope of the disclosure.

It should be understood that steps described in a method embodiment of the disclosure can be executed in and/or parallel. Further, the method embodiment can include an additional step and/or omit a shown step, which does not limit the scope of the disclosure.

As used herein, the terms “comprise”, “include” and their variations are open-ended, that is, “comprise but not limited to” and “include but not limited to”. The term “based on” indicates “at least partially based on”. The term “an embodiment” indicates “at least one embodiment”. The term “another embodiment” indicates “at least another one embodiment”. The term “some embodiments” indicates “at least some embodiments”. Related definitions of other terms will be given in the following description.

It should be noted that concepts such as “first” and “second” mentioned in the disclosure are merely used to distinguish different apparatuses, modules or units, rather than limit the order or interdependence of functions executed by these apparatuses, modules or units.

It should be noted that a modification with “a” and “an” mentioned in the disclosure is illustrative rather than limitative, and should be understood by those skilled in the art as “one or more” unless otherwise definitely indicated in the context.

It should be noted that a step of obtaining the personal data of a user mentioned in the disclosure is executed with the authorization of the user. For example, in response to receiving an active request from the user, prompt information is sent to the user to clearly remind the user that a requested operation require obtaining and using the personal data of the user. Thus, the user can independently determine, according to the prompt information whether to provide personal information for software or hardware such as an electronic device, an application, a server or a storage medium that executes an operation of the technical solution of the disclosure. As an optional but non-limitative implementation, in response to receiving an active request from the user, the prompt information may be sent to the user through, for example, a pop-up window. In the pop-up window, the prompt information may be presented in text. In addition, a selection control may be carried in the pop-up window for the user to select “yes” or “no” to provide the personal data for the electronic device. It can be understood that the above process of notifying and obtaining authorization of the user is merely illustrative, and does not limit an implementation of the disclosure. Other methods satisfying relevant laws and regulations may also be applied to the implementation of the disclosure. It can be understood that the data involved in this technical solution (including but not limited to the data, data obtaining or use) should comply with the requirements of corresponding laws, regulations and relevant provisions.

A name of a message or information exchanged among a plurality of apparatuses in the implementation of the disclosure is merely used for illustration rather than limitation to the scope of the message or information.

A solution provided by the embodiment of the disclosure will be described below in detail with reference to the accompanying drawings.

In one or more embodiments of the disclosure, mixed reality technology can combine reality and virtuality through a computer, thereby providing the user with a mixed reality space for human-computer interaction. In the mixed reality space, the user can perform social interaction, entertainment, study, work, telecommuting, creation of a user generated content (UGC), etc. through a mixed reality device such as a head mount display (HMD).

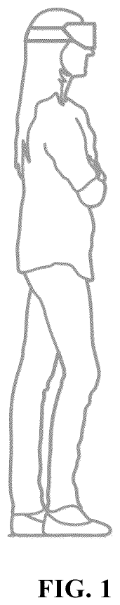

With reference to FIG. 1, the user may enter the mixed reality space through the mixed reality device such as head mount glasses, and control an avatar thereof to perform social interaction entertainment, study, telecommuting, etc. with avatars controlled by other users in the mixed reality space.

In the mixed reality space in the related art as shown in FIG. 1, the user may implement a related interaction operation through one or more input devices in communication with the electronic device. The input device includes a controller (such as a handle) connected to the device.

The mixed reality device described in the embodiment of the disclosure may include, but is not limited to, the following types:

A computer-side mixed reality device uses a computer to perform related computations and data output of a mixed reality function. The external computer-side mixed reality device uses data output by the computer to achieve a mixed reality effect.

A mobile extension device supports setting of a mobile terminal (such as a smart phone) in various ways (such as a head-mounted display with a special clamping slot). Through a wired or wireless connection to the mobile terminal, the mobile terminal performs related computations of a mixed reality function and outputs data to the mobile mixed reality device. For example. a mixed reality video is watched through an application (App) of the mobile terminal.

An all-in-one mixed reality device has a processor for related computations of the mixed reality function, has independent mixed reality input and output functions accordingly. and does not need to be connected to the computer side or the mobile terminal. Thus. a high degree of freedom of use is achieved.

It is clear that an implementation form of the mixed reality device is not limited to the form described above, and can be further miniaturized or enlarged as needed.

In a mixed reality world (the world generated through mixed reality technology), a virtual model corresponding to an object (such as an article) in the real world may be displayed. When the virtual model is displayed, it is necessary to calibrate the object in the real world. Calibration usually includes determination of a position and a size of the object in the real world, and may also give the object some physical attributes (such as an occlusion attribute and a collision attribute). Thus, the virtual model that has the same size as and coincides, in position, with the object may be displayed in the mixed reality world. The mixed reality world is usually displayed by using the mixed reality device. In the related art, the mixed reality device usually has paired handles, and operation convenience may be insufficient when the calibration operation is performed through the handles.

### Visual Tracking

In some embodiments of the disclosure, an eye tracking device in the electronic device (for example, a head-mounted electronic device) visually tracks eyes of a user. Visual information of the user, such as a line of sight, a gaze point, etc. of the user may be obtained through the eye tracking device. In an embodiment, the eye tracking device includes at least one eye tracking camera (for example, an infrared (IR) or near infrared (NIR) camera), and an illumination source (for example, an IR or NIR light source, such as an array or ring of light-emitting diodes (LEDs)) that emits light (for example, IR or NIR light) towards the eyes of the user. The eye-tracking camera may point to the eyes of the user, so as to receive IR or NIR light directly reflected from the eyes by the light source, or alternatively may point to “hot” mirrors located between the eyes of the user and a display panel. These hot mirrors reflect the IR or NIR light from the eyes to the eye tracking camera while allowing visible light to pass through. A gaze tracking device randomly captures images of the eyes of the user (for example, as a video stream captured at 60 to 120 frames per second (fps)), analyzes these images to generate gaze tracking information, and transmits the gaze tracking information to the electronic device. In this way, some human-computer interaction functions can be performed based on the gaze information of the user, such as content navigation based on the gaze information. In some embodiments, two eyes of the user are tracked separately through corresponding eye tracking cameras and illumination sources. In some embodiments, merely one eye of the user is tracked through a corresponding eye tracking camera and an illumination source.

### Gesture Tracking

In some embodiments of the disclosure, a gesture detection device in the electronic device detects hand information of the user. The hand information of the user, such as a hand gesture of the user, may be obtained through the gesture detection device. The hand gesture detection device is a part of the electronic device (for example, embedded in or attached to a head-mounted device). In some embodiments, the gesture detection device includes an image sensor (for example, one or more IR cameras, three-dimensional (3D) cameras, depth cameras and/or color cameras) that captures three-dimensional scenario information including at least hands of the human user. The image sensor captures a hand image with sufficient resolution. Thus, fingers and corresponding positions can be distinguished. In some embodiments, the gesture detection device captures and processes a time series containing a depth mapping image of the hand of the user when the user moves the hand (for example, the whole hand or one or more fingers). Software run on the image sensor and processor of the electronic device processes 3D mapping data. so as to extract image block descriptors of the hand in these depth mapping images. The software can match, based on a previous learning process, these descriptors with image block descriptors stored in a database, so as to estimate a pose of the hand in each frame. The pose usually includes 3D positions of hand joints and finger tips of the user. The software may also analyze trajectories of the hand and/or the finger in a plurality of frames in the series, so as to recognize a gesture. A pose estimation function according to the disclosure may be alternated with a motion tracking function. Thus, pose estimation based on the image blocks is merely performed once every two (or more) frames. The tracking is performed to find a change of the pose occurs on the remaining frames and provide pose, motion and gesture information for the application run on the electronic device. For example, the program may move and modify the image presented on the display generation component of the electronic device in response to the pose and/or gesture information, or execute other functions, for example, a control instruction corresponding to the gesture.

### Calibration Process

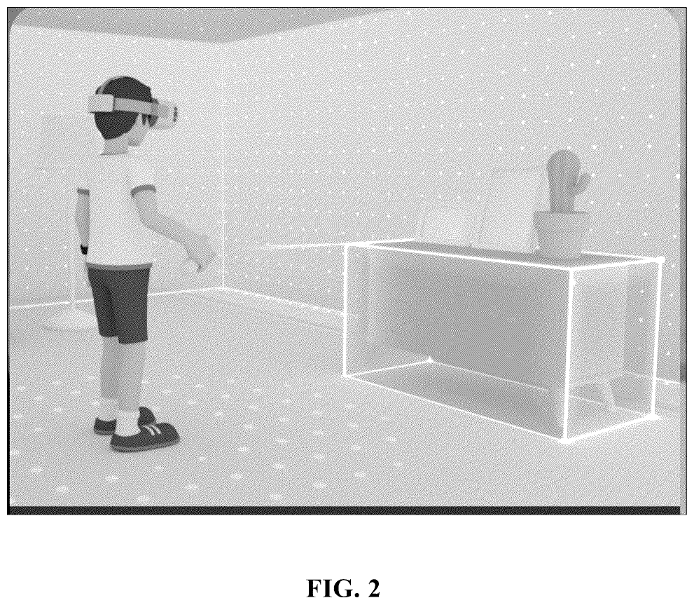

In some embodiments of the disclosure, for example, a forward-facing camera (an RGB camera or/and depth camera) on a head-mounted electronic device captures a graphic of a physical environment, then merges the same with a computer-generated image in real time, and displays an merged result on the display generation component. Thus, the user has a feeling that the surrounding real world can be seen with eyes directly through the electronic device, and such a function can be referred to as a perspective function. With the perspective function of the electronic device, an object in the physical environment may be calibrated (see FIG. 2). Calibration mainly means that the user helps the electronic device understand the physical environment and have an occlusion relation and a collision relation of the physical environment by drawing, in a certain way, an outline of the object, for example, a room, in the physical environment.

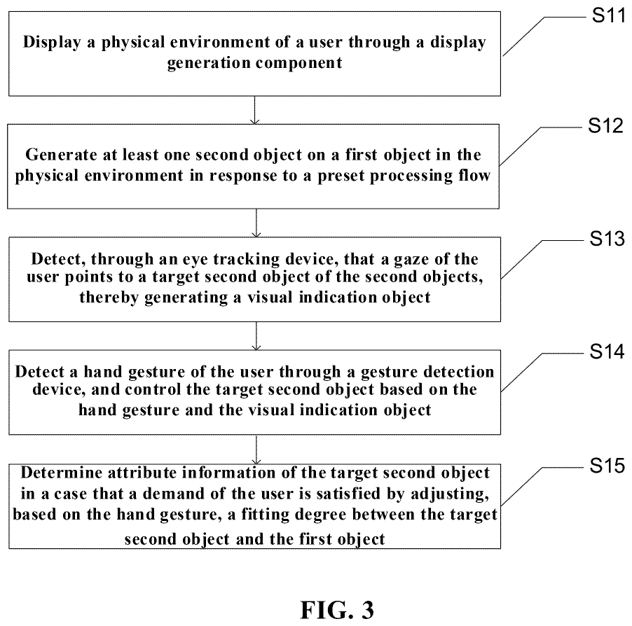

As shown in FIG. 3, FIG. 3 is a flowchart of a method for controlling an electronic device according to an embodiment of the disclosure. The electronic device includes: a display generation component and one or more input devices. The display generation component may be a head-mounted display. The input device includes an eye tracking device and a gesture detection device, and the eye tracking device may perform detection during use of the electronic device. The method includes:
S11: displaying. through the display generation component, a physical environment of a user.
S12: generating at least one second object on a first object in the physical environment in response to a preset processing flow:
S13: detecting, through the eye tracking device, that a gaze of the user points to a target second object of the second objects, thereby generating a visual indication object.
S14: detecting a hand gesture of the user through the gesture detection device, and controlling the target second object based on the hand gesture and the visual indication object.
S15: determining attribute information of the target second object in a case that a demand of the user is satisfied by adjusting, based on the hand gesture, a fitting degree between the target second object and the first object.

In some embodiments, the electronic device of the method according to the disclosure may be a mixed reality device, and the user may be a user who wears and uses the electronic device. When using the mixed reality device, the user may execute a preset processing flow (such as a calibration process) after real physical environment is displayed for the current user in the electronic device. The first object is a real object in the real physical environment, for example, an article in the real physical environment, and may be an entity such as a wall, a floor or a piece of furniture. The first object is also displayed in the mixed reality world. The mixed reality world is a world displayed by the display generation component, and includes the real physical environment and a virtual object. The eye tracking device on the electronic device may have a function of detecting eyes of the user, so as to determine a line of sight of the user. According to the line of sight of the user, the target second object of the second object(s) is determined, and if a number of the second object is one, the second object may be determined as the target second object. For example, the second object to which the line of sight of the user points is the target second object. The second object is an object related to the first object in the mixed reality world, for example, a virtual model corresponding to the first object or a part of the virtual model, and the second object may be a purely virtual object.

In some embodiments, the visual indication object may be configured to present a position of the line of sight of the user, and may be a cursor. The user may control the target second object, for example, adjust a position, size, etc. by performing a gesture operation (that is, a hand gesture) in combination with the visual indication object. In some embodiments of the disclosure, a pointing direction of the line of sight of the user may be used to provide position navigation. The hand gestures may provide a further operation, and control may be implemented by combining the line of sight and the hand gesture. The target second object and the first object have a fitting degree, for example, a similarity. The user may execute a specific gesture operation to indicate that the fitting degree satisfies the demand of the user. In this case, the attribute information of the target second object will be determined, and the attribute information of the target second object may be fixed in this case.

In some embodiments of the disclosure, the target second object is selected based on the gaze of the user, and the second object is controlled by using the hand gesture and the visual indication object. An external control tool such as a handle is unnecessary during the entire process, the first object can be calibrated by the method. use experience of the user is better compared with a method using a handle, and interaction convenience is expanded.

In some embodiments of the disclosure, detecting that a gaze of the user points to a target second object of the second objects through the eye tracking device includes: in a case of a glance or a gaze of a line of sight of the user at a second object, the score of the second object under the glance or the gaze is changed, and alternatively, a score of the rest second object other than the second object under the glance or the gaze is changed, where the second objects have corresponding scores; and the target second object is determined according to the score of the second object.

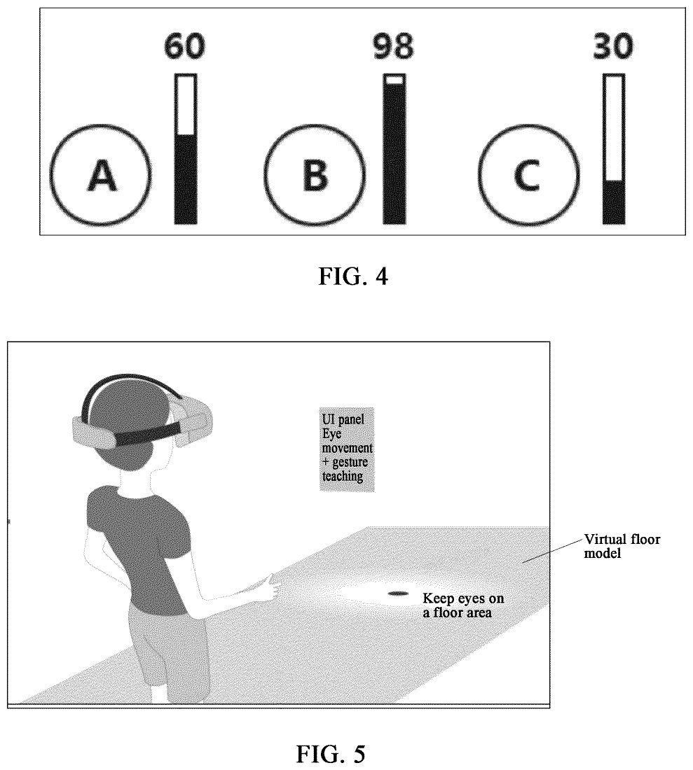

In some embodiments, the line of sight of the user may wander to some extent. In order to better determine the target second object to which the line of sight of the user is fixed. as shown in FIG. 4. a preset score, for example, 100 points. may be set for the second object (such as an article) in the mixed reality world. The score of the second object may remain unchanged or increase when the user glances or gazes at the second object in the mixed reality world. The score of the second object at which the user does not glance or gaze may decrease when the user does not glance or gaze at the second object in the mixed reality world. A second object with a high final score may be used as the target second object, that is, the second object at which the user glances frequently or gazes for a long time, indicating that the user gazes at the second object.

In some embodiments of the disclosure, detecting that a gaze of the user points to a target second object of the second objects through the eye tracking device includes: in response to receiving first voice information indicating a selection intention, a second object to which the line of sight of the user points when the first voice information is received is taken as the target second object.

In some embodiments, when the line of sight of the user points to a second object, the current user may send out the first voice information, for example, the current user may say “calibrate it”, “select it”, etc. The first voice information does not need to include a name of the second object, and the first voice information indicates a selection intention of the user. In this case, the second object to which the line of sight of the user points in the mixed reality world is thus the target second object. The second object may be a purely virtual object rather than a real object in the physical environment. The attribute information of the target second object includes one or more of the following: a size of the target second object, a position of the target second object, a shape of the target second object, a posture of the target second object and semantics of the target second object. The semantics of the target second object may refer to a type of the target second object, such as a wall surface, a floor, furniture, etc.

In some embodiments of the disclosure, detecting a hand gesture of the user through the gesture detection device, and controlling the target second object based on the hand gesture and the visual indication object, include: the hand gesture of the user is detected through the gesture detection device, and the attribute information of the target second object is adjusted in combination with the visual indication object and in response an adjustment instruction the hand gesture.

In some embodiments, one or more of the attribute information of the target second object may be adjusted. For example, one or more of the size, the position, the shape, the posture and the semantics of the target second object may be adjusted, such that the target second object has the same size, position, shape, posture as its corresponding first object and/or is the same type as the first object. In this way, in the mixed reality world, the electronic device may learn about the first object through the target second object. The first object may be processed based on the attribute of the target second object. For example, if a collision effect between the virtual object and the first object is desired. an interaction effect between the target second object and the virtual object may be computed, so as to implement interaction between the physical environment and the virtual object.

In some embodiments, the method further includes: the fitting degree between the target second object and the first object is determined to satisfy the demand of the user in response to a first type of gesture operation. In some embodiments, the user may execute the first type of gesture operation to indicate that a current second object and first object satisfy the demand of the user.

In some embodiments of the disclosure, in a case that the first object is the floor, there may be merely one second object, the second object is gazed at by the user and then regarded as the target second object. The second object is a plane indication object corresponding to the floor. and the plane indication object may be any virtual object that may represent a plane, such as a virtual floor model, a virtual border and a virtual plane coordinate. Detecting a hand gesture of the user through the gesture detection device, and controlling the target second object based on the hand gesture and the visual indication object, include: the plane indication object is lifted or lowered in response to determining that the visual indication object is located at the plane indication object and the hand gesture is a second type of gesture operation.

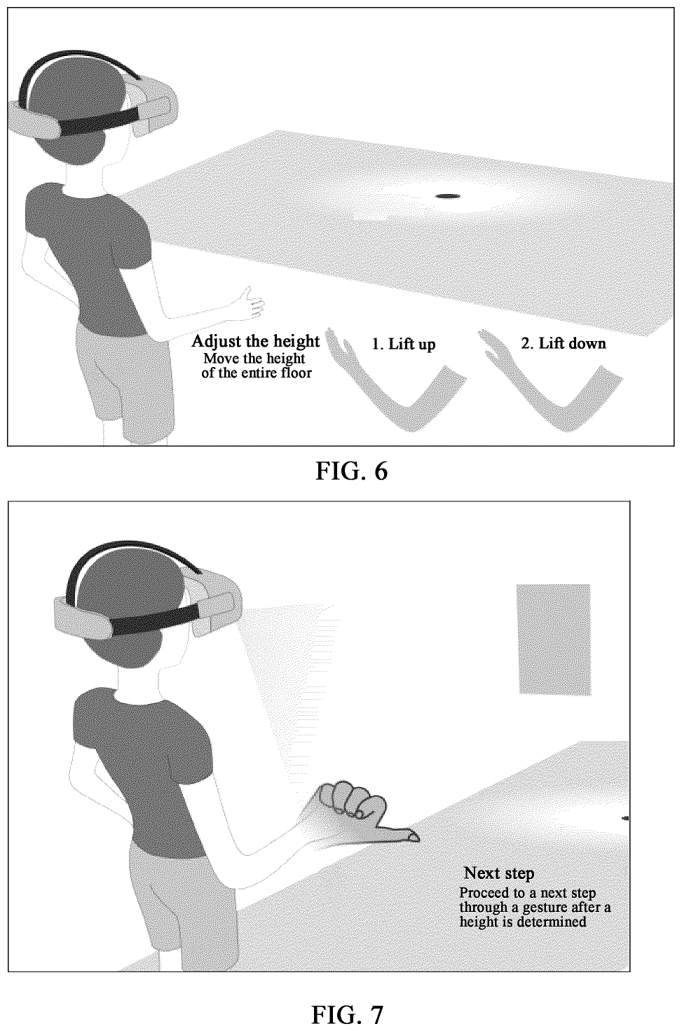

In some embodiments of the disclosure, in a case that the first object is the floor, a virtual floor model (plane indication object) corresponding to the floor is generated and displayed after entering the calibration process (preset processing flow). When the line of sight of the user points to the virtual floor model, the virtual floor model is determined as the target second object. As shown in FIGS. 5-7, after entering a floor calibration process, the position of the floor may be computed through a floor monitoring algorithm and a virtual floor model may be generated. The virtual floor model may be an infinite or finite plane, and the plane may be parallel to the floor. When the line of the user points to the virtual floor model, a cursor is displayed on the virtual floor model as the visual indication object, indicating that the user selects the virtual floor model as the target second object. As shown in FIG. 6, when the visual indication object is located on the virtual floor model, the second type of gesture operation may be executed. The second type of gesture operation is a specific type of gesture operation, for example, lifting or lowering of an arm. After the second type of gesture operation is recognized. the virtual floor model is lifted or lowered (for example, the virtual floor model is lifted or lowered at a fixed speed). Thus, the current user may adjust the position of the virtual floor model through the second type of gesture operation. so as to realize the floor calibration. Then, if the first type of gesture operation is detected (see FIG. 7), the attribute information such as a height position of the current virtual floor model is recorded. so to complete the floor calibration.

In some embodiments of the disclosure, the second object is a skirting line model of each skirting line of a wall surface in a case that the first object is the wall surface. Detecting that a gaze of the user points to a target second object of the second objects through the eye tracking device includes: a target skirting line model is determined as the target second object in response to that the line of sight of the user points to the target skirting line model. Detecting a hand gesture of the user through the gesture detection device and controlling the target second object based on the hand gesture and the visual indication object include: the target skirting line model is calibrated in response to that the visual indication object is located on the target skirting line model and the hand gesture is a third type of gesture operation. Determining attribute information of the target second object in a case that a demand of the user is satisfied by adjusting, based on the hand gesture, a fitting degree between the target second object and the first object, includes: attribute information of a calibrated skirting line model is determined after the calibrated skirting line model forms a virtual closed surface, and the virtual closed surface is taken as a virtual wall surface model for calibrating the wall surface.

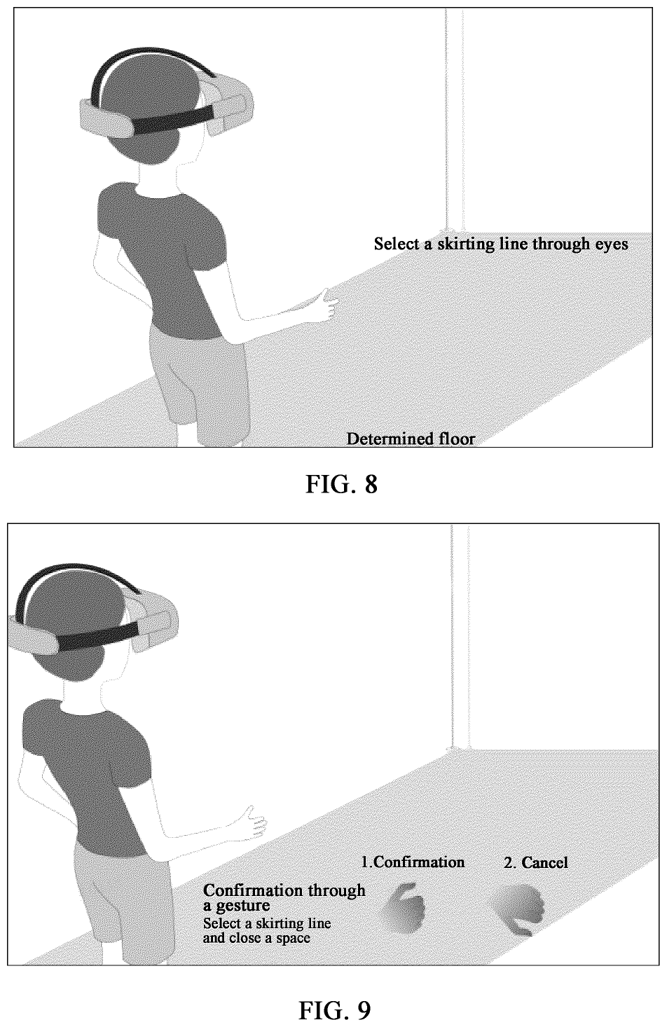

In some embodiments, the preset processing flow for calibrating the wall may be automatically entered after completing the preset processing flow for calibrating the floor. In this case, the first object is the wall, as shown in FIG. 8, the line of sight of the current user points to one skirting line model of the wall surface, and the skirting line model being pointed to may be highlighted as the target second object. Then. the user may execute the third type of gesture operation to confirm calibration of the target skirting line (as shown in FIG. 9).

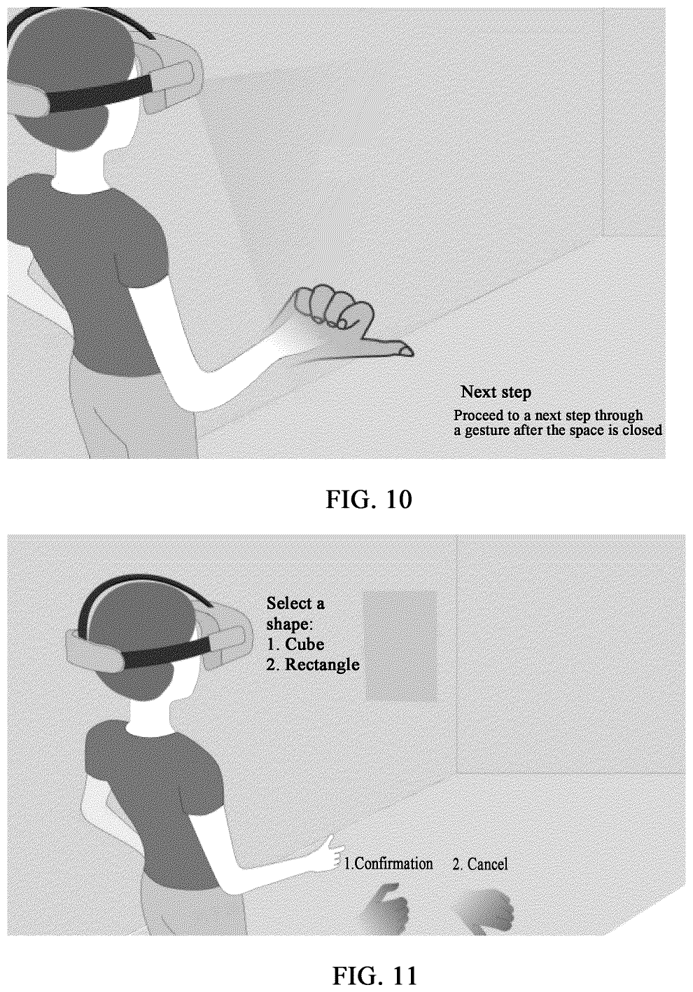

Then, the above actions are repeated to calibrate other skirting line models of the wall surface. After the calibrated skirting line models define a closed surface, all skirting line models of the wall surface are calibrated. These skirting line models define the closed surface that will be used as the virtual wall surface model of the wall, and the virtual wall surface model may overlap with the wall. Then, as shown in FIG. 10, the first type of gesture operation is performed to complete calibration of the wall.

In some embodiments of the disclosure, the second object is a virtual shape model corresponding to a piece of furniture in a case that the first object is the piece of furniture. Detecting that a gaze of the user points to a target second object of the second objects through the eye tracking device includes: a target shape model to which the line of sight points is determined as the target second object according to the line of sight of the user. Determining attribute information of the target second object in a case that a demand of the user is satisfied by adjusting. based on the hand gesture, a fitting degree between the target second object and the first object, includes: attribute information of the target shape model is determined in response to a fourth type of gesture operation.

In some embodiments, a preset flow for calibrating the furniture is automatically entered after the preset flow of calibrating the wall is completed. As shown in FIG. 11, when the furniture is calibrated, a shape model may be displayed. There may be a plurality of shape models, for example, the cube and the rectangle in FIG. 11. The shape model to which the line of sight of the user points is the target shape model. If the user executes a fourth type of gesture operation (the fourth type of gesture operation may be the same as the third type of gesture operation), for example, a thumb makes a pressing action, the attribute information of the target shape model may be selected and confirmed. The target shape model is taken as a virtual furniture model, and the virtual furniture model is a model corresponding to the furniture in the mixed reality world. The furniture may be calibrated to generate a virtual furniture model that has the same size and shape as the furniture and coincides, in position, with the furniture.

In some embodiments of the disclosure, detecting a hand gesture of the user through the gesture detection device, and controlling the target second object based on the hand gesture and the visual indication object, include: a third object is determined according to the visual indication object, and a virtual target shape model is displayed at a position of the third object. The target shape model is positioned at the current position of the target shape model in response to a fifth type of gesture operation.

In some embodiments, after selecting the target shape model, the current user may display the target shape model at the position of the third object by looking at the third position such as the floor, the wall or the ceiling, and then position the target shape model at its current position, for example, the position of the third object, by performing a fifth type of gesture operation, such as making a fist. For example. the target shape model may be the cube or the rectangle that may have a default size. The default size of the cube may be 1.2 m×0.7 m×1.5 m. and the default size of the rectangle may be 1 m×1 m.

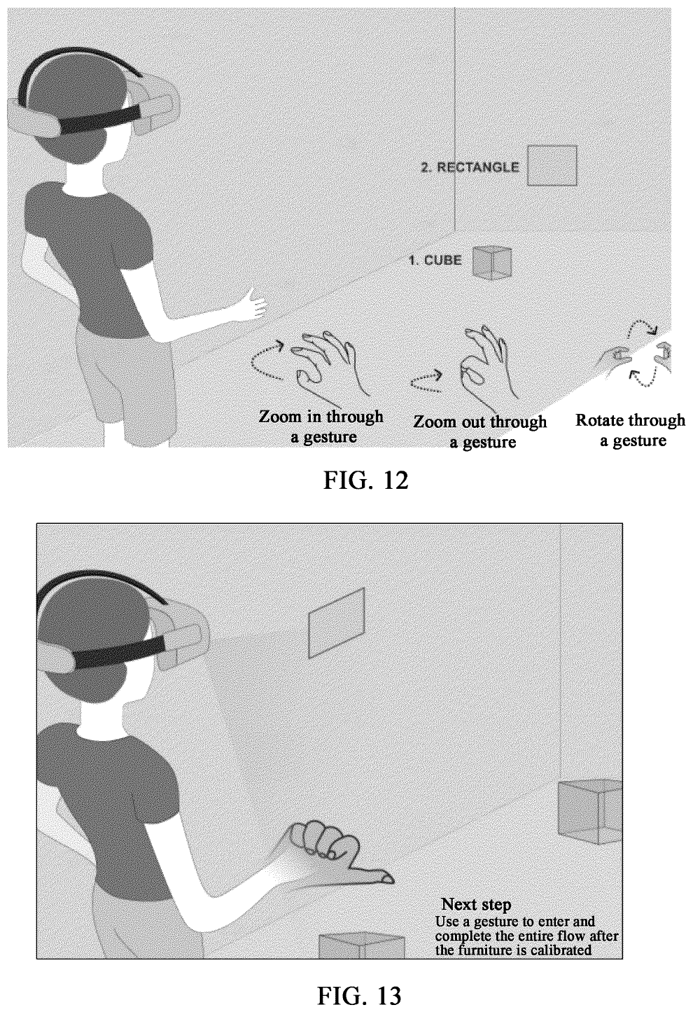

In some embodiments of the disclosure, detecting a hand gesture of the user through the gesture detection device, and controlling the target second object based on the hand gesture and the visual indication object, further include: a target edge in the target shape model is determined according to the visual indication object, and a size of the target edge is adjusted in response to a sixth type of gesture operation executed by the user. In some embodiments, the target edge may be any edge in the target shape model, and as shown in FIG. 12, the size of the target edge may be enlarged or reduced through, for example, two-finger zooming (sixth gesture operation). In some embodiments, a maximum threshold and a minimum threshold of the edge are preset. The size of the target edge cannot be set to be greater than the maximum threshold or smaller than the minimum threshold. The maximum threshold may be 3 m and the minimum threshold may be 0.1 m since the furniture in the real environment is not exceedingly large or small.

In some embodiments of the disclosure, detecting a hand gesture of the user through the gesture detection device, and controlling the target second object based on the hand gesture and the visual indication object, further include: the target shape model is rotated in response to a seventh type of gesture operation executed. in a case that the visual indication object is located on the target shape model, by the user. In some embodiments, the seventh type of gesture operation may be grasp gestures by two hands plus clockwise or counterclockwise rotation, such that the target shape model also rotates clockwise or counterclockwise.

In some embodiments of the disclosure, detecting a hand gesture of the user through the gesture detection device, and controlling the target second object based on the hand gesture and the visual indication object, further include: the target shape model is moved in response to an eighth type of gesture operation executed, in a case that the visual indication object is located on the target shape model, by the user. In some embodiments, the eighth type of gesture operation may be, for example, movement in upward, downward, leftward, rightward, forward or backward direction after grasping by two hands, through which the virtual furniture model may be moved in the upward, downward, leftward, rightward, forward or backward direction correspondingly. When the eighth type of gesture operation is used to move the virtual furniture model, a movement speed may be less than a movement speed at which the virtual furniture model is moved through the line of sight, which is convenient for fine adjustment through the eighth type of gesture operation.

In some embodiments, as shown in FIG. 13, the preset processing flow for calibrating the furniture may be completed by executing the first type of gesture operation, and the whole calibration flow may be completed at this point.

In some embodiments of the disclosure, the interaction between eye tracking and the gesture is added, the visual indication object such as the cursor is controlled through the line of sight of the eyes to select and move the target second object, and the gesture is used for the real-time operation. An interaction method is expanded through various modal interactions, such that dependence on the handle may be reduced. The method may be used to calibrate the room in a mixed reality scenario.

Some embodiments of the disclosure further provide an electronic device. The electronic device may be a mixed reality device, for example, a head-mounted mixed reality device. The electronic device includes: a display generation component and one or more input devices, where the input device includes an eye tracking device and a gesture detection device.

The display generation component is configured to display a physical environment of a user.

The display generation component is further configured to generate at least one second object on a first object in the physical environment in response to a preset processing flow.

The eye tracking device is configured to detect a pointing direction of a gaze of the user.

The display generation component is further configured to detect, through the eye tracking device, that the gaze of the user points to a target second object of the second objects, and generate a visual indication object. The gesture detection device is configured to detect a hand gesture of the user.

The display generation component is further configured to detect the hand gesture of the user through the gesture detection device, and control the target second object based on the hand gesture and the visual indication object.

The display generation component is further configured to determine attribute information of the target second object in a case that a demand of the user is satisfied by adjusting, based on the hand gesture, a fitting degree between the target second object and the first object.

In some embodiments, where detecting, through the eye tracking device, that the gaze of the user points to the target second object of the second objects includes:

in a case of a glance or a gaze of a line of sight of the user at a second object, changing a score of the second object under the glance or the gaze, or changing a score of the rest second object other than the second object under the glance or the gaze; and determining the target second object according to the score of the second object, where the second objects have corresponding scores; or

taking as the target second object, in response to receiving first voice information indicating a selection intention, a second object to which the line of sight of the user points when the first voice information is received.

In some embodiments,
the second object is a virtual object; and/or
the attribute information of the target second object includes one or more of the following: a size of the target second object, a shape of the target second object, a position of the target second object, a posture of the target second object and semantics of the target second object; and/or
in some embodiments, the gesture detection device is further configured to determine that the fitting degree between the target second object and the first object satisfies the demand of the user in response to a first type of gesture operation.

In some embodiments, controlling the target second object based on the hand gesture and the visual indication object includes: detecting the hand gesture of the user through the gesture detection device, and adjusting the attribute information of the target second object in combination with the visual indication object and in response to an adjustment instruction corresponding to the hand gesture.

In some embodiments, the second object is a virtual plane indication object corresponding to a floor in a case that the first object is the floor.

detecting the hand gesture of the user through the gesture detection device and controlling the target second object based on the hand gesture and the visual indication object includes: lifting or lowering the plane indication object in response to determining that the visual indication object is located at the plane indication object and the hand gesture is a second type of gesture operation.

In some embodiments, the second object is a skirting line model of each skirting line of a wall surface in a case that the first object is the wall surface;
the detecting, through the eye tracking device, that a gaze of the user points to a target second object of the second objects includes: determining a target skirting line model as the target second object in response to that the line of sight of the user points to the target skirting line model;
detecting the hand gesture of the user through the gesture detection device and controlling the target second object based on the hand gesture and the visual indication object include: calibrating the target skirting line model in response to determining that the visual indication object is located on the target skirting line model and the hand gesture is a third type of gesture operation; and
determining attribute information of the target second object in a case that the demand of the user is satisfied by adjusting, based on the hand gesture, the fitting degree between the target second object and the first object, includes: determining attribute information of a calibrated skirting line model after the calibrated skirting line model forms a virtual closed surface, and taking the virtual closed surface as a virtual wall surface model for calibrating the wall surface.

In some embodiments, the second object is a virtual shape model corresponding to a piece of furniture in a case that the first object is the piece of furniture;
the detecting, through the eye tracking device, that a gaze of the user points to a target second object of the second objects includes: determining a target shape model to which the line of sight points as the target second object according to the line of sight of the user; and
determining attribute information of the target second object in a case that the demand of the user is satisfied by adjusting, based on the hand gesture, a fitting degree between the target second object and the first object, includes: determining attribute information of the target shape model in response to a fourth type of gesture operation.

In some embodiments, detecting the hand gesture of the user through the gesture detection device and controlling the target second object based on the hand gesture and the visual indication object include:
determining a third object according to the visual indication object, and displaying a virtual target shape model at a position of the third object; and

positioning the target shape model at a current position of the target shape model in response to a fifth type of gesture operation.

In some embodiments, detecting the hand gesture of the user through the gesture detection device and controlling the target second object based on the hand gesture and the visual indication object further include one or more of the following:
determining a target edge in the target shape model according to the visual indication object, and adjusting a size of the target edge in response to a sixth type of gesture operation executed by the user;
rotating the target shape model in response to a seventh type of gesture operation executed, in a case that the visual indication object is located on the target shape model, by the user; and
moving the target shape model in response to an eighth type of gesture operation executed, in a case that the visual indication object is located on the target shape model, by the user.

As for an apparatus embodiment, since this embodiment basically corresponds to the method embodiment, reference can be made to the partial description of the method embodiment for relevant contents. The apparatus embodiments described above are merely illustrative, the modules described as separated modules can be physically separated, or not. Some or all modules may be selected according to actual needs to achieve the purposes of the solutions of the embodiments. What is described above can be understood and implemented by those skilled in the art without creative efforts.

The method and the apparatus of the disclosure are described above based on embodiments and application examples. In addition, the disclosure further provides an electronic device and a computer-readable storage medium. The electronic device and the computer-readable storage medium are described below.

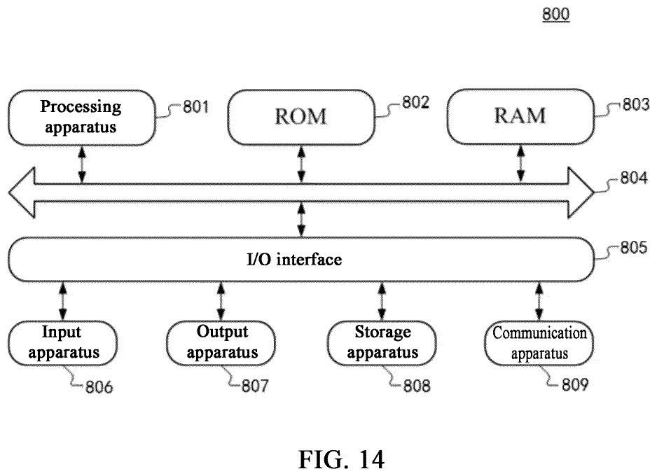

With reference to FIG. 14, a schematic structural diagram of the electronic device 800 (for example, a terminal device or a server) applied to implementation of the embodiment of the disclosure is shown. A terminal device in the embodiment of the disclosure may include, but are not limited to, a mobile terminal such as a mobile phone, a notebook computer, a portable android device (PAD) and a head-mounted virtual reality (VR) device. The electronic device described below is merely an example, and should not limit in any extent a function and an application scope of the embodiment of the disclosure.

The electronic device 800 may include a processing apparatus 801 (for example, a central processing unit and a graphics processing unit), which may execute various appropriate actions and processing according to a program stored in a read-only memory (ROM) 802 or loaded from a storage apparatus 808 to a random access memory (RAM) 803. The RAM 803 may further store various programs and data required for the operation of the electronic device 800. The processing apparatus 801, the ROM 802, and the RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touch pad, a keyboard, a mouse, a camera, a microphone, an accelerometer and a gyroscope, an output apparatus 807 including, for example, a liquid crystal display (LCD), a speaker and a vibrator, the storage apparatus 808 including, for example, a magnetic tape and a hard disk, and a communication apparatus 809. The communication apparatus 809 may allow the electronic device 800 to be in wireless or wired communication with other devices for data exchange. Although the electronic device 800 having various apparatuses is shown in the figure, it should be understood that not all the devices shown herein are required to be implemented or provided. More or fewer apparatuses may be alternatively implemented or provided.

Specifically, according to the embodiment of the disclosure, a process described above with reference to the flowchart may be implemented as a computer software program. For example, the embodiment of the disclosure includes a computer program product. The computer program product includes a computer program carried on a computer-readable medium. and the computer program includes program codes for executing the method shown in the flowchart. In such an embodiment, the computer program may be downloaded and installed from the network through the communication apparatus 809, or installed from the storage apparatus 808, or installed from the ROM 802. When executed by the processing apparatus 801, the computer program executes the above functions defined in the method of the embodiment of the disclosure.

It should be noted that the computer-readable medium described above in the disclosure may be a computer-readable signal medium or a computer-readable storage medium or their any combination. For example, the computer-readable storage medium may be, but are not limited to, an electric, magnetic, optical, electromagnetic, infrared, or semiconductor system, apparatus or device, or any combination thereof. More specific examples of the computer-readable storage medium may include, but is not limited to, an electrical connection having one or more wires. a portable computer disk, a hard disk, a random access memory (RAM), a read-only memory (ROM), an erasable programmable read-only memory (EPROM) or a flash memory, an optical fiber, a portable compact disk read-only memory (CD-ROM), an optical storage device, a magnetic storage device, or any suitable combination thereof. In the disclosure, the computer-readable storage medium may be any tangible medium including or storing a program, and the program may be used by or in combination with an instruction execution system, apparatus or device. In the disclosure, the computer-readable signal medium may include a data signal propagated in a baseband or as part of a carrier wave, in which a computer-readable program code is carried. This propagated data signal may have a plurality of forms, including but not limited to an electromagnetic signal, an optical signal or any suitable combination thereof. The computer-readable signal medium may further be any computer-readable medium other than the computer-readable storage medium, and the computer-readable signal medium may send, propagate or transmit a program used by or in combination with the instruction execution system, apparatus or device. A program code included in the computer-readable medium may be transmitted through any suitable medium, including but not limited to: a wire, an optical cable, a radio frequency (RF) medium. etc., or any suitable combination thereof.

In some embodiments, a client side and a server may communicate by using any currently known or future developed network protocol such as the hypertext transfer protocol (HTTP), and may be interconnected to digital data communication (for example, a communication network) in any form or medium. Examples of the communication network include a local area network (“LAN”), a wide area network (“WAN”), internet work (for example, the Internet), an end-to-end network (for example, adhoc end-to-end network), and any currently-known or future-developed network.

The computer-readable medium may be included in the electronic device, or exist independently without being assembled into the electronic device.

The computer-readable medium carries one or more programs, and when executed by the electronic device, the one or more programs cause the electronic device to execute the method of the disclosure.

Computer program codes for executing the operations of the disclosure may be written in one or more programming languages or their combinations, and the programming languages include object-oriented programming languages such as Java, Smalltalk and C++, and further include conventional procedural programming languages such as “C” language or similar programming languages. The program codes may be completely executed on a computer of the user, partially executed on the computer of the user, executed as an independent software package, partially executed on the computer of the user and a remote computer separately, or completely executed on the remote computer or the server. In the case of involving the remote computer, the remote computer may be connected to the computer of the user through any type of network, including a local area network (LAN) or a wide area network (WAN), or may be connected to an external computer (for example, through the Internet provided by an Internet service provider).

The flowcharts and block diagrams in the accompanying drawings illustrate the architectures, functions and operations that may be implemented by the systems, the methods and the computer program products according to various embodiments of the disclosure. In this regard, each block in the flowchart or block diagram may represent one module, one program segment, or a part of codes that includes one or more executable instructions for implementing specified logical functions. It should also be noted that in some alternative implementations, the functions indicated in the blocks may occur in an order different than those indicated in the accompanying drawings. For example, two blocks indicated in succession may actually be executed in substantially parallel, and may sometimes be executed in a reverse order depending on the functions involved. It should also be noted that each block in the block diagram and/or flowchart, and a combination of blocks in the block diagram and/or flowchart may be implemented by a specific hardware-based system that executes specified functions or operations, or may be implemented by a combination of specific hardware and computer instructions.

The units involved in the embodiment of the disclosure may be implemented by software or hardware. The name of the unit does not limit the unit itself in some cases.

The functions described above herein may be executed at least in part by one or more hardware logic components. For example, in a non-limitative manner, illustrative types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the disclosure, a machine-readable medium may be a tangible medium, and may include or store a program that is used by or in combination with the instruction execution system, apparatus or device. The machine-readable medium may be a machine-readable signal medium or a machine-readable storage medium. The machine-readable medium may include, but is not limited to, an electric, magnetic, optical, electromagnetic, infrared, or semiconductor system, apparatus or device, or their any suitable combination. More specific examples of the machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or their any suitable combination.

A method for controlling an electronic device is provided according to one or more embodiments of the disclosure. The electronic device includes a display generation component and one or more input devices the input device includes an eye tracking device and a gesture detection device. The method includes:
displaying, through the display generation component, a physical environment of a user;
generating, in response to a preset processing flow, at least one second object on a first object in the physical environment;
detecting, through the eye tracking device, that a gaze of the user points to a target second object of the second objects, to generate a visual indication object;
detecting a hand gesture of the user through the gesture detection device, and controlling the target second object based on the hand gesture and the visual indication object; and
determining attribute information of the target second object in a case that a demand of the user is satisfied by adjusting, based on the hand gesture, a fitting degree between the target second object and the first object.

In the method for controlling an electronic device according to one or more embodiments of the disclosure, detecting, through the eye tracking device, that the gaze of the user points to the target second object of the second objects includes:
in a case that the user glances or gazes at the second object, changing a score of a second object under the glance or the gaze, or changing a score of the rest second object other than the second object under the glance or the gaze; and determining the target second object according to the score of the second object, where the second objects have corresponding scores; or
taking as the target second object, in response to receiving first voice information indicating a selection intention, a second object to which the line of sight of the user points when the first voice information is received.

In the method for controlling an electronic device according to one or more embodiments of the disclosure, the second object is a virtual object; and/or
the attribute information of the target second object includes one or more of the following: a size of the target second object, a shape of the target second object, a position of the target second object, a posture of the target second object, and semantics of the target second object; and/or
the fitting degree between the target second object and the first object is determined to satisfy the demand of the user in response to a first type of gesture operation.

In the method for controlling an electronic device according to one or more embodiments of the disclosure, detecting the hand gesture of the user through the gesture detection device and controlling the target second object based on the hand gesture and the visual indication object include:
detecting the hand gesture of the user through the gesture detection device, and adjusting the attribute information of the target second object in combination with the visual indication object and in response to an adjustment instruction corresponding to the hand gesture.

In the method for controlling an electronic device according to one or more embodiments of the disclosure, the second object is a virtual plane indication object corresponding to a floor in a case that the first object is the floor; and
the detecting the hand gesture of the user through the gesture detection device and controlling the target second object based on the hand gesture and the visual indication object include: lifting or lowering the plane indication object in response to determining that the visual indication object is located at the plane indication object and the hand gesture is a second type of gesture operation.

In a method for controlling an electronic device according to one or more embodiments of the disclosure, the second object is a skirting line model of each skirting line of a wall surface in a case that the first object is the wall surface;
the detecting, through the eye tracking device, that a gaze of the user points to a target second object of the second objects includes: determining a target skirting line model as the target second object in response to that the line of sight of the user points to the target skirting line model;
detecting the hand gesture of the user through the gesture detection device and controlling the target second object based on the hand gesture and the visual indication object include: calibrating the target skirting line model in response to determining that the visual indication object is located on the target skirting line model and the hand gesture is a third type of gesture operation; and
determining attribute information of the target second object in a case that the demand of the user is satisfied by adjusting, based on the hand gesture, the fitting degree between the target second object and the first object, includes: determining attribute information of a calibrated skirting line model after the calibrated skirting line model forms a virtual closed surface, and taking the virtual closed surface as a virtual wall surface model for calibrating the wall surface.

In a method for controlling an electronic device according to one or more embodiments of the disclosure, the second object is a virtual shape model corresponding to a piece of furniture in a case that the first object is the piece of furniture;
detecting, through the eye tracking device, that a gaze of the user points to a target second object of the second objects includes: determining a target shape model to which the line of sight points as the target second object according to the line of sight of the user; and
determining attribute information of the target second object in a case that the demand of the user is satisfied by adjusting. based on the hand gesture, a fitting degree between the target second object and the first object, includes: determining attribute information of the target shape model in response to a fourth type of gesture operation.

In the method for controlling an electronic device according to one or more embodiments of the disclosure, detecting the hand gesture of the user through the gesture detection device and controlling the target second object based on the hand gesture and the visual indication object include:
determining a third object according to the visual indication object, and displaying a virtual target shape model at a position of the third object; and
positioning the target shape model at a current position of the target shape model in response to a fifth type of gesture operation.

In the method for controlling an electronic device according to one or more embodiments of the disclosure, detecting the hand gesture of the user through the gesture detection device and controlling the target second object based on the hand gesture and the visual indication object further include one or more of the following:
determining a target edge in the target shape model according to the visual indication object, and adjusting a size of the target edge in response to a sixth type of gesture operation executed by the user;
rotating the target shape model in response to a seventh type of gesture operation executed, in a case that the visual indication object is located on the target shape model, by the user; and
moving the target shape model in response to an eighth type of gesture operation executed, in a case that the visual indication object is located on the target shape model, by the user.

An electronic device is provided according to one or more embodiments of the disclosure. a display generation component and one or more input devices, where the input device includes an eye tracking device and a gesture detection device;
the display generation component is configured to display a physical environment of a user;
the display generation component is further configured to generate at least one second object on a first object in the physical environment in response to a preset processing flow;
the eye tracking device is configured to detect a pointing direction of a gaze of the user;
the display generation component is further configured to detect, through the eye tracking device, that the gaze of the user points to a target second object of the second objects, to generate a visual indication object;
the gesture detection device is configured to detect a hand gesture of the user;
the display generation component is further configured to detect the hand gesture of the user through the gesture detection device, and control the target second object based on the hand gesture and the visual indication object; and
the display generation component is further configured to determine attribute information of the target second object in a case that a demand of the user is satisfied by adjusting, based on the hand gesture, a fitting degree between the target second object and the first object.

An electronic device is provided according to one or more embodiments of the disclosure. The electronic device includes: at least one processor and a memory.

The at least one memory is configured to store program codes, and the at least one processor is configured to execute any method described above by calling the program codes stored in the at least one memory.

A computer-readable storage medium is provided according to one or more embodiments of the disclosure. The computer-readable storage medium is configured to store program codes, where the program codes, when run by a processor, cause the processor to execute the method described above.

What is described above is merely explanation of preferred embodiments of the disclosure and applied technical principles. It should be understood by those skilled in the art that the disclosed scope involved in the disclosure is not limited to the technical solution formed by a specific combination of the technical features described above, but further covers other technical solution formed by any random combination of the technical features described above or their equivalent features without departing from the concepts described above of the disclosure, for example, a technical solution formed by interchanging the features described above and (non-limitative) technical features having similar functions as disclosed in the disclosure.

In addition, although the operations are depicted in a particular order, it should not be understood that these operations are required to be executed in the particular order shown or in a sequential order. In certain circumstances, multi-task and parallel processing may be advantageous. Similarly, although several specific implementation details are included in the discussion described above, these details should not be construed as limitation to the scope of the disclosure. Some features described in the context of a separate embodiment can be further implemented in a single embodiment in a combination manner. On the contrary, various features described in the context of a single embodiment can be further implemented in a plurality of embodiments separately or in any suitable sub-combination manner.

Although the subject matter has been described in language specific to structural features and/or 10 methodological logical actions, it should be understood that the subject matter defined in the appended claims is not necessarily limited to the specific features or actions described above. On the contrary, the specific features and actions described above are merely illustrative implementation forms of the claims.

I/We claim:

1. A method for controlling an electronic device, wherein the electronic device comprises a display generation component and one or more input devices, and the input device comprises an eye tracking device and a gesture detection device; and the method comprises:
displaying, through the display generation component, a physical environment of a user;
generating, in response to a preset processing flow, at least one second object on a first object in the physical environment;
detecting, through the eye tracking device, that a gaze of the user points to a target second object of the second objects, to generate a visual indication object;
detecting a hand gesture of the user through the gesture detection device, and controlling the target second object based on the hand gesture and the visual indication object; and
determining attribute information of the target second object in a case that a demand of the user is satisfied by adjusting, based on the hand gesture, a fitting degree between the target second object and the first object.

2. The method according to claim 1, wherein detecting, through the eye tracking device, that the gaze of the user points to the target second object of the second objects comprises:
in a case of a glance or a gaze of a line of sight of the user at a second object, changing a score of the second object under the glance or the gaze of the line of sight or changing a score of a rest second object other than the second object under the glance or the gaze of the line of sight; and determining the target second object according to the score of the second object, wherein the second objects have corresponding scores; or
taking as the target second object, in response to receiving first voice information indicating a selection intention, a second object to which a line of sight of the user points when the first voice information is received.

3. The method according to claim 1, wherein
the second object is a virtual object; and/or
the attribute information of the target second object comprises one or more of a size of the target second object, a shape of the target second object, a position of the target second object, a posture of the target second object, and semantics of the target second object; and/or
the fitting degree between the target second object and the first object is determined to satisfy the demand of the user in response to a first type of gesture operation.

4. The method according to claim 1, wherein detecting the hand gesture of the user through the gesture detection device and controlling the target second object based on the hand gesture and the visual indication object comprise:
detecting the hand gesture of the user through the gesture detection device, and adjusting the attribute information of the target second object in combination with the visual indication object and in response to an adjustment instruction corresponding to the hand gesture.

5. The method according to claim 1, wherein
the second object is a virtual plane indication object corresponding to a floor in a case that the first object is the floor; and
detecting the hand gesture of the user through the gesture detection device and controlling the target second object based on the hand gesture and the visual indication object comprise: lifting or lowering the plane indication object in response to determining that the visual indication object is located at the plane indication object and the hand gesture is a second type of gesture operation.

6. The method according to claim 1, wherein
the second object is a skirting line model of each skirting line of a wall surface in a case that the first object is the wall surface;
detecting, through the eye tracking device, that the gaze of the user points to the target second object of the second objects comprises: determining a target skirting line model as the target second object in response to that a line of sight of the user points to the target skirting line model;
detecting the hand gesture of the user through the gesture detection device and controlling the target second object based on the hand gesture and the visual indication object comprise: calibrating the target skirting line model in response to determining that the visual indication object is located on the target skirting line model and the hand gesture is a third type of gesture operation; and
determining attribute information of the target second object in a case that the demand of the user is satisfied by adjusting, based on the hand gesture, the fitting degree between the target second object and the first object, comprises: determining attribute information of a calibrated skirting line model after the calibrated skirting line model forms a virtual closed surface, and taking the virtual closed surface as a virtual wall surface model for calibrating the wall surface.

7. The method according to claim 1, wherein
the second object is a virtual shape model corresponding to a piece of furniture in a case that the first object is the piece of furniture;
detecting, through the eye tracking device, that the gaze of the user points to the target second object of the second objects comprises: determining a target shape model to which a line of sight of the user points as the target second object according to the line of sight; and
determining attribute information of the target second object in a case that the demand of the user is satisfied by adjusting, based on the hand gesture, a fitting degree between the target second object and the first object, comprises: determining attribute information of the target shape model in response to a fourth type of gesture operation.

8. The method according to claim 7, wherein detecting the hand gesture of the user through the gesture detection device and controlling the target second object based on the hand gesture and the visual indication object comprise:
determining a third object according to the visual indication object, and displaying a virtual target shape model at a position of the third object; and
positioning the target shape model at a current position of the target shape model in response to a fifth type of gesture operation.

9. The method according to claim 8, wherein detecting the hand gesture of the user through the gesture detection device and controlling the target second object based on the hand gesture and the visual indication object further comprise one or more of:
determining a target edge in the target shape model according to the visual indication object, and adjusting a size of the target edge in response to a sixth type of gesture operation executed by the user;
rotating the target shape model in response to a seventh type of gesture operation executed, in a case that the visual indication object is located on the target shape model, by the user; and
moving the target shape model in response to an eighth type of gesture operation executed, in a case that the visual indication object is located on the target shape model, by the user.

10. An electronic device, comprising:
at least one memory and at least one processor;
wherein the at least one memory is configured to store program codes, and the program codes, when called by the at least one processor, cause the at least one processor to:
display, through a display generation component, a physical environment of a user;
generate, in response to a preset processing flow, at least one second object on a first object in the physical environment;
detect, through an eye tracking device, that a gaze of the user points to a target second object of the second objects, to generate a visual indication object:
detect a hand gesture of the user through a gesture detection device, and control the target second object based on the hand gesture and the visual indication object; and
determine attribute information of the target second object in a case that a demand of the user is satisfied by adjusting, based on the hand gesture, a fitting degree between the target second object and the first object.

11. The electronic device according to claim 10, wherein the at least one processor, when caused to detect, through the eye tracking device, that the gaze of the user points to the target second object of the second objects, is to:
in a case of a glance or a gaze of a line of sight of the user at a second object, change a score of the second object under the glance or the gaze of the line of sight or change a score of a rest second object other than the second object under the glance or the gaze of the line of sight; and determine the target second object according to the score of the second object, wherein the second objects have corresponding scores; or
take as the target second object, in response to receiving first voice information indicating a selection intention, a second object to which a line of sight of the user points when the first voice information is received.

12. The electronic device according to claim 10, wherein
the second object is a virtual object; and/or
the attribute information of the target second object comprises one or more of a size of the target second object, a shape of the target second object, a position of the target second object, a posture of the target second object, and semantics of the target second object; and/or
the fitting degree between the target second object and the first object is determined to satisfy the demand of the user in response to a first type of gesture operation.

13. The electronic device according to claim 10, wherein the at least one processor, when caused to detect the hand gesture of the user through the gesture detection device and control the target second object based on the hand gesture and the visual indication object, is to:
detect the hand gesture of the user through the gesture detection device, and adjust the attribute information of the target second object in combination with the visual indication object and in response to an adjustment instruction corresponding to the hand gesture.

14. The electronic device according to claim 10, wherein
the second object is a virtual plane indication object corresponding to a floor in a case that the first object is the floor; and
the at least one processor, when caused to detect the hand gesture of the user through the gesture detection device and control the target second object based on the hand gesture and the visual indication object, is to: lift or lower the plane indication object in response to determining that the visual indication object is located at the plane indication object and the hand gesture is a second type of gesture operation.

15. The electronic device according to claim 10, wherein
the second object is a skirting line model of each skirting line of a wall surface in a case that the first object is the wall surface;
the at least one processor, when caused to detect, through the eye tracking device, that the gaze of the user points to the target second object of the second objects, is to: determine a target skirting line model as the target second object in response to that a line of sight of the user points to the target skirting line model;
the at least one processor, when caused to detect the hand gesture of the user through the gesture detection device and control the target second object based on the hand gesture and the visual indication object, is to: calibrate the target skirting line model in response to determining that the visual indication object is located on the target skirting line model and the hand gesture is a third type of gesture operation; and
the at least one processor, when caused to determine attribute information of the target second object in a case that the demand of the user is satisfied by adjusting, based on the hand gesture, the fitting degree between the target second object and the first object, is to: determine attribute information of a calibrated skirting line model after the calibrated skirting line model forms a virtual closed surface, and take the virtual closed surface as a virtual wall surface model for calibrating the wall surface.

16. The electronic device according to claim 10, wherein
the second object is a virtual shape model corresponding to a piece of furniture in a case that the first object is the piece of furniture;
the at least one processor, when caused to detect, through the eye tracking device, that the gaze of the user points to the target second object of the second objects, is to: determine a target shape model to which a line of sight of the user points as the target second object according to the line of sight; and
the at least one processor, when caused to determine attribute information of the target second object in a case that the demand of the user is satisfied by adjusting, based on the hand gesture, a fitting degree between the target second object and the first object, is to: determine attribute information of the target shape model in response to a fourth type of gesture operation.

17. The electronic device according to claim 16, wherein the at least one processor, when caused to detect the hand gesture of the user through the gesture detection device and control the target second object based on the hand gesture and the visual indication object, is to:
determine a third object according to the visual indication object, and display a virtual target shape model at a position of the third object; and
position the target shape model at a current position of the target shape model in response to a fifth type of gesture operation.

18. The electronic device according to claim 17, wherein the at least one processor, when caused to detect the hand gesture of the user through the gesture detection device and control the target second object based on the hand gesture and the visual indication object, is further to perform one or more of:
determining a target edge in the target shape model according to the visual indication object, and adjusting a size of the target edge in response to a sixth type of gesture operation executed by the user;
rotating the target shape model in response to a seventh type of gesture operation executed, in a case that the visual indication object is located on the target shape model, by the user; and
moving the target shape model in response to an eighth type of gesture operation executed, in a case that the visual indication object is located on the target shape model, by the user.

19. A non-transitory computer-readable storage medium, configured to store program codes, wherein the program codes, when run by a processor, cause the processor to:
display; through a display generation component, a physical environment of a user;
generate, in response to a preset processing flow, at least one second object on a first object in the physical environment;
detect, through an eye tracking device, that a gaze of the user points to a target second object of the second objects, to generate a visual indication object;
detect a hand gesture of the user through a gesture detection device, and control the target second object based on the hand gesture and the visual indication object; and
determine attribute information of the target second object in a case that a demand of the user is satisfied by adjusting, based on the hand gesture, a fitting degree between the target second object and the first object.

20. The non-transitory computer-readable storage medium according to claim 19, wherein
the second object is a virtual object; and/or
the attribute information of the target second object comprises one or more of a size of the target second object, a shape of the target second object, a position of the target second object, a posture of the target second object, and semantics of the target second object; and/or
the fitting degree between the target second object and the first object is determined to satisfy the demand of the user in response to a first type of gesture operation.
